(19) United States
(12) Patent Application Publication
(10) Pub. No.: US 2012/0232752 A1
(43) Pub. Date: Sep. 13, 2012

(54) ARCHITECTURE FOR CABIN MANAGEMENT

(75) Inventors: FREDERIC REYNAUD, Jouars Pontchatrain (FR); Frederic Paci, Montigny Le Bretonneux (FR)

(73) Assignee: INTERTECHNIQUE, Plaisir Cedex (FR)

(21) Appl. No.: 13/414,774

(22) Filed: Mar. 8, 2012

Related U.S. Application Data
(60) Provisional application No. 61/451,640, filed on Mar. 11, 2011.

(51) Int. Cl. G06F 19/00

(52) U.S. Cl. 701/36

(57) ABSTRACT

Disclosed are various embodiments for a cabin management system that increases data throughput and decreases transmission delay via at least two dual channel time-triggered bus. In one embodiment, the cabin management system comprises a cabin management controller for controlling the cabin management system and interfacing with a plurality of avionics of an aircraft. The cabin management system further comprises a plurality of equipment controllers for generically interfacing with the cabin equipment of the aircraft. Additionally, the dual channel time-triggered data buses transmit data between the cabin management controller and the cabin equipment controllers based on a time triggered protocol.

### CROSS-REFERENCE TO RELATED APPLICATION

This application claims the benefit of U.S. Provisional Application No. 61/451,640 filed on Mar. 11, 2011, the contents of which are incorporated herein by reference.

### BACKGROUND

A cabin of an aircraft includes a variety of cabin equipment, such as, one or more passenger service panels, lighting fixtures, water and waste management systems, a passenger addressing system, and/or other equipment commonly found in a cabin. Each passenger seat and/or row of passenger seats may be associated with a passenger service panel that controls lighting above the respective passenger seat, airflow of an air vent associated with the respective passenger seat, service requests for the passenger and/or other controls available to each passenger. The cabin equipment of the aircraft may also be displaced throughout the cabin on many sides of the aircraft.

Additionally, each passenger service panel may be associated with a loudspeaker for broadcasting audio information. For example, a pilot may communicate vital information to passengers over the loudspeaker while the aircraft is in midair. This audio information transmitted via the passenger service panel may require a large amount of data flow between a handset being used by the pilot to the loudspeaker associated with the passenger service panel. Additionally, any delay between the handset and the loudspeaker is desired to be as short as possible to avoid receiving feedback and/or echo while the handset is in use. For example, a delay over a certain threshold amount may create an echo that causes the pilot to hear his or her own voice over the loudspeaker while the pilot is attempting to speak.

Many cabin management systems are anchored by a high bandwidth bus as the backbone of their architecture. For example, the high bandwidth bus may use the Ethernet 100BaseT high-speed standard. An architecture employing a high bandwidth bus uses a star topology where each node of the network is linked to a central node requiring a variety of switches, wiring, and additional equipment. Additionally, the high bandwidth bus may require an additional intermediary component to interface directly with all of the cabin equipment. Furthermore, a high bandwidth bus may introduce delay in the transmission of data between the components of the cabin management systems.

### SUMMARY OF THE INVENTION

Disclosed are embodiments for a cabin management system comprising a cabin management controller for controlling the cabin management system and interfacing with a plurality of avionics of an aircraft. The cabin management system further comprises a plurality of cabin equipment controllers for generically interfacing with cabin equipment of the aircraft. Additionally, the cabin management system comprises at least two dual channeled time-triggered data buses for transmitting data between the cabin management controller and the cabin equipment controllers, wherein the time-triggered data buses are associated with a time triggered protocol.

Disclosed are embodiments for an aircraft cabin management controller configured to transmit, via a dual channel time-triggered bus, digital data for managing cabin equipment to a plurality of cabin equipment controllers, wherein the cabin equipment controllers relay the digital data to the cabin equipment. Additionally, the aircraft cabin management controller is further configured to receive digital data from the cabin equipment controllers.

Disclosed are embodiments for a cabin equipment controller configured to receive, via a dual channel time-triggered bus, digital data from a cabin management main controller. The cabin equipment controller is further configured to interface with the cabin equipment and/or one or more passenger service panels of an aircraft based on the received digital data. The cabin equipment controller is additionally configured to acquire a plurality of discrete inputs from the cabin equipment and the passenger service panels and transmit, via the dual channel time-triggered bus, the discrete inputs to the cabin management main controller.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is an exemplary drawing of a cabin management system according to various embodiments of the present disclosure.

FIG. 2 is an exemplary drawing of a cabin equipment controller as described in the cabin management system of FIG. 1 according to certain embodiments of the present disclosure.

### DETAILED DESCRIPTION

Disclosed are embodiments for a cabin management system to manage cabin equipment and passenger service panels of an aircraft via a multipoint and dual channel time-triggered bus. The cabin management system comprises a cabin management main controller that transmits data to and receives data from one or more cabin equipment controllers displaced throughout the aircraft. Each cabin equipment controller is configured to serve as a generic interface to the cabin equipment and the passenger service panels. The cabin equipment controllers receive data from the cabin management main controller via the dual channel time-triggered bus based on a time-triggered protocol. The cabin equipment controllers then communicate with the cabin equipment and transmit data from the cabin equipment to the cabin management main controller via the dual channel time-triggered bus based on the time-triggered protocol. Therefore, a cabin management system permitting increased data throughput, decreased transmission errors, and decreased delay is disclosed. In the following discussion, a general description of the system and its components is provided, followed by a discussion of the operation of the same.

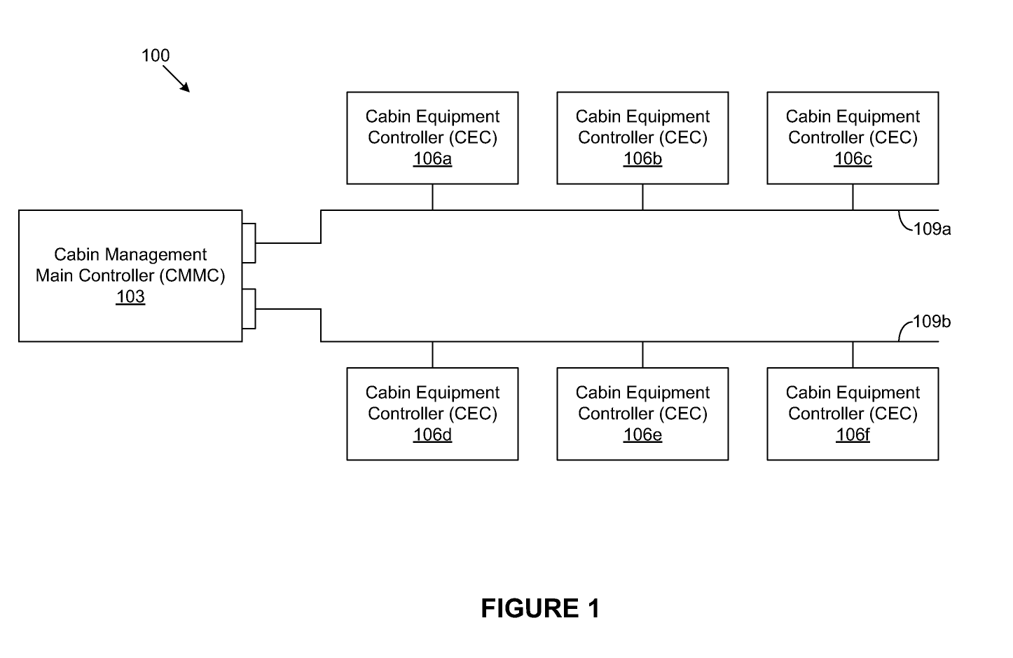

FIG. 1 shows a cabin management system 100 comprising a cabin management main controller (CMMC) 103, a plurality of cabin equipment controllers (CECs) 106a-106f, and a plurality of main buses 109a and 109b. In one embodiment, the CMMC 103 manages and controls the functions of the cabin management system 100. For example, the CMMC 103 communicates with the CECs 106 via the buses 109 and interfaces with the avionics of the aircraft. In one embodiment, the avionics of the aircraft comprises one or more electronic systems used on the aircraft. For example, the electronic systems may manage the communications, navigation, radar, and/or any other electronic system related to the operation of the aircraft.

In one embodiment, the CMMC 103 interfaces with the cabin equipment via the CECs 106. The cabin equipment may be displaced throughout the cabin of the aircraft and may include one or more smoke detectors, galleys, lavatories and lighting fixtures. Additionally, the CMMC 103 interfaces with one or more passenger service panels via the CECs 106. For example, each passenger seat of the aircraft may be associated with a passenger service panel that interfaces with individual lights, buttons, a loudspeaker, a plurality of LED signs, and/or any other device associated with a passenger seat. The CMMC 103 communicates with the cabin equipment and the passenger service panels by transmitting data via the main buses 109a and 109b to the CECs 106. The CECs 106 may then relay the data to the respective cabin equipment and the passenger service panels.

The cabin management system 100 may include dual main buses 109a and 109b where each bus is displaced on opposite sides of the aircraft. For example, the main bus 109a may be displaced on a starboard side of the aircraft and may carry data between the CMMC 103 and the CECs 106 displaced on the starboard side. Similarly, the main bus 109b may be displaced on a port side of the aircraft and may carry data between the CMMC 103 and the CECs 106 displaced on the port side.

Additionally, each main bus 109 may be a dual channel time-triggered bus operating under a FlexRay protocol, a TTcan protocol, and/or a time-triggered protocol. For example, a time-triggered protocol operates on a dual channel bus where certain data is replicated on both channels. In one embodiment, any data related to safety may be replicated on both channels to ensure that the data is accurately transmitted. The time-triggered protocol comprises a static portion and a dynamic portion. In the static portion of the time-triggered protocol, data is transmitted on the time-triggered bus based on a predetermined schedule. In one embodiment, the predetermined schedule includes reserved slots for transmitting various types of data. Under this protocol, the data transmitted between the CMMC 103 and the CEC 106 is periodically refreshed based on the frequency of the reserved slot within the predetermined schedule.

In one embodiment, according to the time-triggered protocol, each type of data having a specific data type is transmitted on the main bus 109 only during the reserved slot for the respective data type. Accordingly, the time-triggered protocol provides event tolerant data to the nodes in communication with the time-triggered bus (i.e., the CECs 106 and the CMMC 103). In this embodiment, the occurrence of an event does not interrupt the predetermined schedule of data transmission. Instead, the response to the occurrence of the event is previously processed and is transmitted on the main bus 109 according to the predetermined schedule such that the response to the occurrence of the event is immediate. Therefore, the reserved slot for the previously processed response to the event occurs in the schedule with a frequency such that the predetermined response to the event is received immediately.

As an example to illustrate the event tolerant transmission, a passenger in a seat may invoke a button on a passenger service panel to turn on a lighting fixture. The response to turn on the lighting fixture may have been previously processed. For example, the response to the passenger invoking the button may be an instruction to turn on the lighting fixture. In one embodiment, this instruction may be transmitted by the CMMC 103 on the main bus 109 to the CEC 106 in the slot revered for the instruction. This reserved slot for the instruction may occur at a frequency in the predetermined schedule such that the instruction is received at the passenger server unit immediately after the passenger invokes the button.

Additionally, the static portion of the time-triggered protocol also includes reserved slots for data bus gateway transmission. For example, data defined by the RS485, RS232, CAN, and/or other telecommunication standard may be transmitted via the reserved slots for the data bus gateway. In one embodiment, the gateway data comprises control signals for managing the cabin equipment and/or the passenger panel. For instance, the CEC 106 receives the control signals from the CMMC 103 at a reserved slot for the data bus gateway as defined by the schedule for the time-triggered protocol. The CEC 106 then relays the control signals to the respective cabin equipment and/or the passenger service panel. Additionally, the CEC 106 may receive responses to the control signals from the respective cabin equipment and/or the passenger service panels and relays the responses to the CMMC 103 at the reserved slot for the data bus gateway as defined by the schedule for the time-triggered protocol.

In the dynamic portion of the time-triggered protocol, data related to unpredictable and/or unplanned events may be transmitted. For example, a portion of the schedule of the time-triggered protocol may include slots reserved for the transmission of data related to the unpredictable events such as maintenance operations, responses to failures, and/or other unpredictable events that may not be planned. The dynamic portion of the time-triggered protocol may be necessary to avoid scheduling all possible responses to all possible unpredictable and/or unplanned events. In one embodiment, scheduling all of the possible responses may require consumption of an amount of resources that exceeds a threshold amount. For example, scheduling all of the possible responses may require too much memory, bandwidth, and/or other resources that may introduce delay and/or decrease data throughput.

As an example of data transmitted in the dynamic portion of the time-triggered protocol, the CMMC 103 may determine that the firmware of the CECs 106 requires an update. The firmware update may then be transmitted on the main buses 109a and 109b in the slot reserved for the dynamic portion of the time-triggered protocol. As another example, a replacement CEC 106 may require testing to ensure that it is properly interfacing with cabin equipment and/or the passenger service panel. One or more commands to test the audio, LEDs, lighting fixtures and/or any other component interfacing with the CEC 106 may be transmitted on the main buses 109a and 109b in the slot reserved for the dynamic portion of the time-triggered protocol. In one embodiment, any data transmitted in the dynamic portion of the time triggered protocol includes header information that identifies the node transmitting the data, the node receiving the data, a type of data, a size of the data, and/or any other identifying information.

Each of the channels of the main bus 109 operate in a mixed redundancy mode. As discussed above, data related to safety may be duplicated on both of the channels. This redundancy may be managed at the CEC 106 or another node of the cabin management system 100. In one embodiment, the CEC 106 decides which channel of the main bus 109 to use for data transmission. The CEC 106 may decide to use the first channel if it determines that the data on the first channel is available and/or valid. If the first channel is not available and/or the data is not valid, the CEC 106 may decide to use the second channel. In one embodiment, a checksum operation may be performed on the data frames of the main bus 109a and 109b to determine whether the data is valid. In another embodiment, the CEC 106 may compute information from the data on the first channel of the main bus 109a and/or 109b, as can be appreciated. If computed information is incorrect, then the CEC 106 may determine that the data from the first channel is not valid and may then determine to use the data on the second channel of the main bus 109a and/or 109b.

In one embodiment, the CMMC 103 identifies each CEC 106 through pin programming. Each of the CECs 106 in the cabin management system 100 may need to be individually identified in order to communicate via a bus operating based a time-triggered protocol. For example, the CMMC 103 may identify the CEC 106 that should receive transmitted data based on a pin of a harness connector associated with the CEC 106.

Additionally, each of the CECs 106 in communication with the CMMC 103 are configured to generically interface with the cabin equipment of the aircraft and the passenger service panels. In one embodiment, the CECs 106 in the cabin management system 100 may be interchangeable and do not receive any data specific to any individual CEC 106. All of the CECs 106 receive the same data from the CMMC 103. Therefore, all of the CECs 106 manage input and output of the data using a similar approach.

In one embodiment, all of the CECs 106 in the cabin management system 100 synchronize based on an equivalent timing concept. For instance, the time-triggered protocol may define the timing concept for all of the nodes in communication with the main buses 109a and 109b. When each node (i.e., the CMMC 103 and the CECs 106a-106f) transmits and/or receives data, the node may first synchronize with the time-triggered protocol before executing the transmission and/or reception of the data.

In operation, the CMMC 103 transmits digital data over the time-triggered main buses 109 based on a time-triggered protocol, as discussed above. For example, the CMMC 103 may receive audio information from a handset of the pilot of the aircraft. The CMMC 103 may transmit a digital audio signal of the audio information via the main buses 109a and 109b to the CECs 106. In one embodiment, the digital audio signal may be dispatched on both channels of the main buss 109a and 109b such that the digital audio signal is received at the destination even if one of the channels is functional. Each of the CECs 106 receives the digital audio signal and converts it to an analog signal. For example, the CEC 106 may be associated with a digital to analog converter as is known in the art to convert the digital signal. Upon converting the digital signal to an audio signal, the CEC 106 may then amplify the converted signal for playback over a loudspeaker. In another embodiment, the CEC 106 may transmit the converted signal to one or more loudspeakers which may then amplify the converted signal before playback.

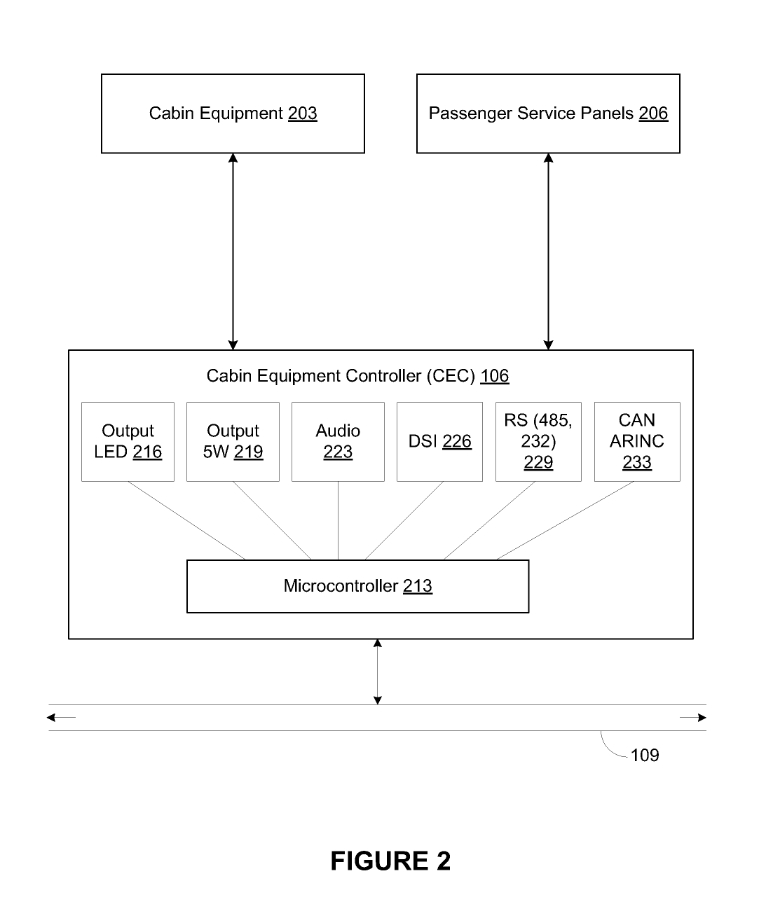

FIG. 2 depicts an exemplary CEC 106 interfacing with the main bus 109, cabin equipment 203, and passenger service panels 206, as discussed above. The CEC 106 receives data from the CMMC 103 (FIG. 1) and transmits data to the CMMC 103 via the main bus 109. Additionally, the CEC 106 interfaces with the cabin equipment 203 and the passenger service panels 206 via point-to-point communication. In one embodiment, the point-to-point communication may comprise a wired and/or a wireless method of communication, as is known in the art.

The CEC 106 includes a microcontroller 213 for processing the data being received from and transmitted to the CMMC 103. In one embodiment, the microcontroller 213 is configured to transmit the data to the respective cabin equipment 203 and the passenger service panels 206 based on the data type of the data received via the main bus 109. For example, the data types may comprise LED output data type 216, 5 W output data type 219, audio data type 223, DSI data type 226, RS data type 229, and CAN data type 233. For example, the LED output data type 216 may be associated with data for managing LED fixtures throughout the cabin of the aircraft. The 5 W output data type 219 may be associated with data for managing individual passenger lights associated with the passenger service panels. The audio data type 223 may be associated with data for broadcasting audio information over one or more loudspeakers displaced throughout the aircraft. The DSI data type 226 may be associate with discrete signal inputs used to receive binary commands from switches such as push buttons for lighting, ventilation and/or other equipment. Additionally, the RSS data type 229 and the CAN data type 233 may be associated with gateway data, as discussed above.

In one embodiment, the microcontroller 213 may determine the data type of the data being received via the main bus 109 and then transmit the data to the respective cabin equipment 203 and/or passenger service panels 206 based on the data type. For example, data associated with the LED output data 216 may be transmitted to lighting fixtures. Data associated with the audio data type 223 may be transmitted to a loudspeaker via a digital to analog converter and an amplifier, as discussed above. Additionally, data associated with the RSS data type 229 and the CAN data type 233 may be transmitted to electronically control the respective cabin equipment 203.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A cabin management system comprising:
a cabin management controller for controlling the cabin management system and interfacing with a plurality of avionics of an aircraft;
a plurality of cabin equipment controllers for generically interfacing with cabin equipment of the aircraft; and
at least two dual channeled time-triggered data buses for transmitting data between the cabin management controller and the cabin equipment controllers, wherein the time-triggered data buses are associated with a time triggered protocol.

2. The cabin management system of claim 1, wherein each cabin equipment controller is further configured for receiving a digital audio signal from the cabin management controller via the time-triggered data buses.

3. The cabin management system of claim 2, wherein each cabin equipment controller is further configured for converting the received digital audio signal to an analogical signal and for amplifying the analogical signal for a loudspeaker.

4. The cabin management system of claim 1, wherein the cabin equipment controllers further interface with at least one passenger service panel.

5. The cabin management system of claim 1, wherein the cabin equipment comprises at least one of a plurality of smoke detectors, a plurality of galleys, a plurality of lavatories, and a plurality of cabin lighting fixtures.

6. The cabin management system of claim 1, wherein the cabin equipment controllers are identified via pin programming.

7. The cabin management system of claim 1, wherein the time triggered protocol comprises static scheduling for refreshing the data transmitted between the cabin equipment controllers and the cabin management controller.

8. The cabin management system of claim 7, wherein the static scheduling comprises transmitting data based on a predetermined schedule, each data to be transmitted being associated with a slot of the schedule.

9. The cabin management system of claim 1, wherein the cabin management controller responds to an event with a previously processed answer that is transmitted periodically based on the time triggered protocol.

10. The cabin management system of claim 8, wherein a plurality of data bus gateways are associated with a plurality of slots of the schedule.

11. The cabin management system of claim 1, wherein the time triggered protocol comprises dynamic scheduling for transmitting maintenance data.

12. The cabin management system of claim 1, wherein the time-triggered data buses are configured to operate in a mixed redundancy mode.

13. The cabin management system of claim 12, wherein the mixed redundancy mode comprises:
determining to use data on a first bus if the data on the first bus is available and invalid; and
determining to use data on a second bus if the data on the first bus is unavailable; and
determining to use data on the second bus if the data on the first bus is invalid.

14. An aircraft cabin management controller configured to:
transmit, via a dual channel time-triggered bus, digital data for managing cabin equipment to a plurality of cabin equipment controllers, wherein the cabin equipment controllers relay the digital data to the cabin equipment; and
receive digital data from the cabin equipment controllers.

15. The aircraft cabin management controller of claim 14, wherein the dual channel time-triggered bus operates based on a time-triggered protocol.

16. The aircraft cabin management controller of claim 14, wherein the cabin equipment controllers are configured to generically interface with at least one of the cabin equipment and a plurality of passenger service panels.

17. The aircraft cabin management controller of claim 16 further configured to preprocess a response to an event received by one of the cabin equipment controllers and transmit the response to the one of the cabin equipment controllers via the dual channel time-triggered bus based on a time-triggered protocol.

18. A cabin equipment controller configured to:
receive, via a dual channel time-triggered bus, digital data from a cabin management main controller;
interface with at least one cabin equipment or at least one passenger service panel of an aircraft based on the received digital data;
acquire a plurality of discrete inputs from the cabin equipment and the passenger service panels; and
transmit, via the dual channel time-triggered bus, the discrete inputs to the cabin management main controller.

19. The cabin equipment controller of claim 18, wherein the dual channel time-triggered bus operates based on a time-triggered protocol.

20. The cabin equipment controller of claim 18, wherein the discrete inputs are transmitted to the cabin management main controller without computation.
